(19) United States
(12) Patent Application Publication
(10) Pub. No.: US 2002/0196392 A1
(43) Pub. Date: Dec. 26, 2002

(54) Color filter and process for producing the same

(75) Inventors: Tetsuo Kawano, Shizuoka-ken (JP); Morimasa Sato, Shizuoka-ken (JP); Yoshio Sakakibara, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/146,069

(22) Filed: May 16, 2002

(30) Foreign Application Priority Data
May 16, 2001 (JP) 2001-146842

(51) Int. Cl. G02F 1/1335

(52) U.S. Cl. 349/104; 349/106

(57) ABSTRACT

The present invention provides a color filter provided on a transparent support, wherein a dot-shaped pattern, having a large number of non-colored regions which do not constitute colored pixels, is provided in at least a part of an area within a single pixel in the direction of layer thickness or layer lamination, among pixels which are patterned with plural colors.

### BACKGROUND OF THE INVENTION

1. Field of the Invention

The present invention relates to a color filter used for liquid crystal color displays, in particular reflective-and-transmissive-type liquid crystal color displays, and to a process for producing the same.

2. Description of the Related Art

In recent years, reflective-type liquid crystal displays have been developed for portable terminals such as mobile telephones, but there is a decrease in display quality when the liquid crystal displays are used indoors or in dark places, and therefore reflective-and-transmissive-type liquid crystal displays have been devised to solve this problem. The principle of the reflective-and-transmissive-type liquid crystal display is that a window for a transmissive display is provided in portions of a reflective layer and a color filter is formed thereon. When the liquid crystal displays are used indoors or in dark places, an image is displayed in a transmissive mode using a backlight. When the liquid crystal displays are used outdoors in sufficient daylight, an image is displayed in a conventional reflective mode. In the color filter of this type, the thickness at a transmissive portion is the same as the thickness at a reflective portion, and hence, when a sufficient amount of light reaches the reflective portion, color purity at the transmissive portion becomes insufficient. Conversely, when sufficient color purity is obtained at the transmissive portion, there is a drawback in that the reflective portion becomes dark.

### SUMMARY OF THE INVENTION

An object of the present invention is to provide a color filter used for a reflective-and-transmissive-type liquid crystal display. Another object of the invention is to provide a process for producing the same by which the color filter can readily be produced.

The present invention relates to a color filter provided on a transparent substrate in which a dot-shaped pattern, having a large number of non-colored regions which do not constitute colored pixels, is provided in at least a part of an area within a single pixel in the direction of layer thickness or layer lamination, among pixels which are patterned with plural colors.

In the color filter of the present invention, it is preferable that non-colored regions which do not constitute colored pixels comprise a transparent non-colored portion or a reflective layer.

Further, in the color filter of the present invention, it is preferable that a large number of transparent non-colored portions, in the shape of a column or a plate, are provided in the direction of the layer thickness of pixels and that the ratio of a transparent non-colored portion to a colored portion within a single pixel is 1:0.1 to 0.1:1, and the area of a transparent non-colored portion in a single pixel is 50 to 10,000 μm².

Still further, in the color filter of the present invention, it is preferable that an overcoat layer is provided on colored pixels.

The process for producing a color filter according to the present invention comprises the steps of:

(1) providing a colored photosensitive resin composition layer on a transparent substrate;

(2) irradiating light through a photomask having a plurality of pixel patterns consisting of a completely light-transmitting region and a dot-shaped light-transmitting region; and

(3) developing the irradiated colored photosensitive resin composition layer and removing unnecessary portions thereof.

In the present invention, it is preferable that the process for producing a color filter further comprises, after the step of (3) developing the irradiated colored photosensitive resin composition layer and removing unnecessary portions thereof, additional steps of:

(4) flood-exposure; and

(5) heat-treatment, and all of the steps (1) to (5) are repeated.

In the step of (1) providing a colored photosensitive resin composition layer on a transparent substrate, it is preferable to use a transfer material comprising a tentative support having disposed thereon a colored photosensitive resin layer so as to transfer a colored photosensitive resin composition layer onto a substrate.

It is also preferable that after a resist material arranged on a transparent substrate is exposed to light through a photomask having a dot-shaped pattern followed by development and heat-treatment, a metal thin film is formed and the formed metal thin film is subjected to a photolithographic processing and then etched to thereby form a reflective layer having a dot-shaped pattern on a transparent substrate.

In the present invention, it is also preferable that the process for producing a color filter further comprises, after the step of (3) developing the irradiated colored photosensitive resin composition layer and removing unnecessary portions thereof, additional steps of:

(6) providing a colorless photosensitive resin composition layer or a colored photosensitive resin composition layer containing a discolorable dye;

(7) irradiating light from the side of a substrate; and

(8) developing the irradiated colorless photosensitive resin composition layer or the irradiated photosensitive resin composition layer containing a discolorable dye and removing unnecessary portions thereof.

### BRIEF DESCRIPTION OF THE DRAWINGS

FIG. 1 is a sectional view of a color filter showing an embodiment of the present invention.

FIG. 2 is a sectional view of a color filter showing another embodiment of the present invention.

### DESCRIPTION OF THE PREFERRED EMBODIMENTS

Description of preferred embodiments of the present invention will be given below.

The color filter of the present invention is characterized in that a dot-shaped pattern, having a large number of non-colored regions which do not constitute colored pixels, is provided in at least a part of an area within a single pixel in the direction of layer thickness or layer lamination, among pixels which are patterned with plural colors arranged on a transparent substrate.

As a transparent substrate, a glass substrate having 0.1 to 2.0 mm in thickness or a polymer film of polyether sulfone, polyarylate, polycarbonate or the like having 10 to 1000 μm in thickness is used.

In the invention, a dot-shaped pattern is provided in a single pixel among colored pixels which are patterned with a plurality of colors of red (R), green (G) and blue (B). In particular, it is desirable that a dot-shaped pattern is provided in at least a part of an area in all of the respective pixels (R), (G) and (B), however, a dot-shaped pattern may be provided in at least a part of an area within a single pixel among a large part of the respective (R), (G) and (B) pixels.

A dot-shaped pattern may be provided in at least a part of an area within a single pixel, and the area having a dot-shaped pattern preferably consists of a colored portion which constitutes a colored pixel at a central region of a single pixel and a portion having a dot-shaped pattern around the central region of a single pixel.

The area having a dot-shaped pattern described above contains a large number of non-colored regions which do not constitute colored pixels in the direction of layer thickness or layer lamination. It is sufficient if colored portions which substantially constitute colored pixels do not exist in these non-colored regions. Accordingly, these non-colored regions may be, for example, 1) an empty portion, 2) a portion containing a transparent colorless material, and 3) a portion having a reflective layer. The 2) portion containing a transparent colorless material is filled with a colorless photosensitive resin composition or a colored photosensitive resin composition containing a dye that is discolored by light and/or heat applied.

In case where the non-colored region which do not constitute colored pixels is 1) an empty portion or 2) a portion containing a transparent colorless material, a ratio of the area of a colored portion to the area of a non-colored portion (i.e., 1) or 2)) within a single pixel is preferably 1:0.1 to 0.1:1, more preferably 0.95:0.5 to 0.7:0.3.

In case where the non-colored region which do not constitute colored pixels is 1) an empty portion or 2) a portion containing a transparent colorless material, the area of a colored portion within a single pixel in a layer surface is preferably 50 to 10,000 μm², more preferably 150 to 9,000 μm^{2.}

In case where the non-colored region which do not constitute colored pixels is 3) a portion having a reflective layer, the area of a colored portion within a single pixel in a layer surface is preferably 50 to 10,000 μm², more preferably 150 to 9,000 μm².

If a color filter has the aforementioned ratio of the area and the aforementioned area of portions, improved reflective-and-transmissive-type liquid crystal displays can readily be produced by using such a color filter in which color purity at a transmissive portion is not impaired even if a sufficient amount of light reaches a reflective portion, while a reflective portion does not grow dark even if color purity at a transmissive portion is sufficient.

In the invention, a dot-shaped pattern refers to a pattern in which a region that does not have a colored portion to constitute a colored pixel is arranged in a large number and in a dot shape, and such a region that does not have a non-colored portion to constitute a colored pixel may have an arbitrary shape of, for example, a column or a plate.

The dot-shaped pattern may be formed by, for example, providing a photosensitive resin composition layer on a transparent substrate and forming a large number of non-colored regions which do not constitute colored pixels by a conventionally known photolithographic processing through a photomask having a pattern of the corresponding dot-shaped pattern, in at least a part of an area within a single pixel in the direction of layer thickness or layer lamination on a transparent substrate.

As the photosensitive resin composition, all of the conventionally known photosensitive resin compositions may be used. Specifically, a photosensitive resin composition containing a negative-type diazo resin and a binder, a photopolymerizable resin composition, a photosensitive resin composition containing an azide compound and a binder, a cinnamic acid type photosensitive resin composition and the like are exemplified. Among these, a photopolymerizable resin composition is particularly preferable, which contains as the basic ingredients a photopolymerization initiator, a photopolymerizable monomer and a binder.

As the photosensitive resin composition, there have been known the compositions which are developable with an aqueous alkaline solution and the compositions which are developable with an organic solvent. It is preferable to use the compositions which are developable with an aqueous alkaline solution from the viewpoints of preventing environmental pollution and securing working safety.

To a photosensitive resin composition layer may further be added red, green and blue coloring matters which develop colors for a color filter. Preferable examples of the coloring matters include Carmine 6B (C. I. 12490), phthalocyanine green (C. I. 74260) and phthalocyanine blue (C. I. 74160). The amount of the coloring matter to be added to the colored photosensitive resin composition is preferably 1 to 30% by weight, more preferably 5 to 20% by weight. The colored photosensitive resin composition may further contain a UV absorbent, suitably in an amount of about 1 to 15% relative to the solid content.

The thickness of a photosensitive resin composition layer disposed on a transparent substrate is determined by the thickness of a layer of colored pixels finally formed on a color filter. In consideration of a difference in level of the layer among pixels, a decrease in the thickness of the layer during heat-treatment such as post-baking, color density in respective colored layers and developing suitability, the thickness of respective colored layers is preferably 0.1 to 5 μm, more preferably 0.3 to 4 μm.

A photosensitive resin composition layer is provided on a transparent substrate by the methods of, for example, 1) coating, 2) printing and 3) transfer. Transfer is particularly preferable in view of simplicity in processing. If necessary, an overcoat layer may be provided on a surface of the colored pixels.

The transfer material for the color filter employed in the 3) method of transfer will be described hereinafter.

Transfer Material Used for Color Filter

The transfer material used for producing a color filter is an image forming material comprising a tentative support having disposed thereon a colored photosensitive resin composition layer. In the present invention, a tentative support to be provided with a colored photosensitive resin composition layer needs to be flexible and does not suffer from significant deformation, shrinkage or elongation even under pressure and/or heating. Examples of the tentative support include polyethylene terephthalate film, triacetate cellulose film, polystyrene film and polycarbonate film. A biaxially oriented polyethylene terephthalate film is particularly preferable.

Desirably, a colored photosensitive resin composition layer is disposed on a tentative support directly or via an interlayer which exhibits good UV ray transmission but poor oxygen permeability. For the purpose of preventing air bubble contamination during transfer, it is preferable to additionally provide a thermoplastic resin layer. In this case, it is also preferable that a thermoplastic resin layer, the interlayer and the photosensitive resin composition layer are successively laminated in this order on a tentative support. These layers can be formed by dissolving the materials for forming each layer in a suitable solvent, coating the resultant solution followed by drying. In this case, when an additional layer is superimposed on a pre-formed layer, the solvent should suitably be selected by those skilled in the art not to adversely affect the lower layers.

An interlayer is provided as a barrier layer for preventing diffusion of oxygen from the air, which hinders photocuring reaction to progress in the colored photosensitive resin composition layer, when conducting patterning exposure after the colored photosensitive resin composition layer has been firmly adhered to a transparent substrate and the tentative support has been removed, and for preventing mixing of the thermoplastic resin layer and the photosensitive resin composition layer in case the above-described three layers are laminated. Accordingly, the interlayer preferably has little likelihood of being mechanically peeled off from the colored photosensitive resin composition layer and has a high ability to shield oxygen.

Such an interlayer is provided by coating a polymer solution onto a tentative support directly or via a thermoplastic resin layer. Suitable polymers used for the interlayer include those polymers described in Japanese Patent Application Publication (JP-B) Nos. 46-32714 and 56-40824, such as polyvinyl ether/maleic anhydride polymers, water-soluble salts of carboxy alkyl cellulose, water-soluble cellulose ethers, water-soluble salts of carboxy alkyl starch, polyvinyl alcohol, polyvinyl pyrrolidone, various kinds of polyacrylamides, various kinds of water-soluble polyamides, water-soluble salts of polyacrylic acid, gelatin, ethylene oxide polymers, water-soluble salts of the group consisting of various kinds of starches and analogues thereof, styrene/maleic acid copolymers, and maleinate resins and the combinations of two or more thereof. A combination of polyvinyl alcohol and polyvinyl pyrrolidone is particularly preferable, having the saponification degree of polyvinyl alcohol desirably of 80% or more.

The addition amount of polymers such as polyvinyl pyrrolidone is preferably 1 to 75% by weight, relative to the solid content of the interlayer, more preferably 1 to 60% by weight, still more preferably 10 to 50% by weight. If the amount is less than 1% by weight, sufficient adhesiveness to the photosensitive resin layer cannot be achieved, while if the amount is greater than 75% by weight, the ability to shield oxygen is lowered. The thickness of the interlayer is very small, as thin as about 0.1 to 5 μm, particularly 0.2 μm. If the thickness of the interlayer is less than 0.1 μm, the oxygen permeability in the interlayer is too high, while if the thickness is greater than 5 μm, a prolonged time is required for development or removing the interlayer.

Preferably, the resin for forming the thermoplastic resin layer has a substantial softening point of 80° C. or lower. The alkali-soluble thermoplastic resin having a softening point of 80° C. or lower is preferably at least one member selected from saponified ethylene/acrylate copolymer, saponified styrene/(meth)acrylate copolymer, saponified vinyl toluene/(meth)acrylate copolymer, poly(meth)acrylate, and saponified (meth)acrylate copolymer of butyl (meth)acrylate and vinyl acetate. Besides, among the organic polymers having a softening point of about 80° C. or lower described in “Plastic Seino Binran” (“Plastic Performance Handbook”, compiled by The Japan Plastics Industry Association and Zen-Nippon Plastic Seikei Kogyo Rengokai and published on Oct. 25, 1968 by Kogyo Chosakai Publishing Co., Ltd.), such resins that are soluble in an aqueous alkaline solution can also be used. Additionally, organic polymers having a softening point higher than 80° C. can be used if various plasticizers compatible therewith and capable of lowering the substantial softening point below 80° C. are incorporated.

In order to control adhesiveness to a tentative support, a variety of polymers, super-cooled substances, adhesion improvers, surfactants, releasing agents, etc. can be added to these organic polymer materials insofar as the substantial softening point does not exceed 80° C. Preferable examples of plasticizers include polypropylene glycol, polyethylene glycol, dioctyl phthalate, diheptyl phthalate, dibutyl phthalate, tricresyl phosphate, cresyl diphenyl phosphate and biphenyl diphenyl phosphate. The thickness of a thermoplastic resin layer is preferably 6 μm or more. The reason for the specified thickness is that if less than 6 μm, uneven portions having difference in level of 1 μm or more of the lower layer cannot be sufficiently soaked up, thus permitting air bubble contamination to readily occur during transfer. The upper limit of the thickness of a thermoplastic resin layer is 100 μm or less, preferably 50 μm or less from the viewpoints of developing properties and manufacturing suitability.

Process for Producing a Color Filter

Description will now be given of a process for producing a color filter using the aforementioned transfer material used for a color filter.

First, a colored photosensitive resin layer is provided on a transparent substrate. If a transparent substrate is provided with a reflective layer by preliminarily patterning, a resist material arranged on an entire surface of the transparent substrate is exposed to light through a photomask having a dot-shaped pattern, developed and heat-treated to form a metal thin film, and thereafter, the formed metal thin film is subjected to a photolithographic processing and then etched such that a dot-shaped reflective layer can be formed on a transparent substrate. The materials for the metal film include Al, Ni, Cr and Ag. As stated above, since the color filter is provided with a dot-shaped reflective layer, lightness at a reflective display can be enhanced to thus obtain a lighter display.

When a colored photosensitive resin composition is provided on a transparent substrate, a tentative support having disposed thereon a photosensitive resin composition layer is laminated, under pressure and heating, onto a glass substrate. Lamination may be conducted using a conventionally known laminator or a vacuum laminator. In order to increase productivity, an auto-cut laminator may be used. Then, the tentative support is peeled off, exposed to light through a pre-arranged photomask, a thermoplastic resin layer and an interlayer, followed by development. Alternatively, the laminated product can be exposed to light before removing the tentative support, and then developed after the removal. In order to obtain high resolution, it is preferable to remove the tentative support before light exposure.

Development is conducted through a known method, such as, by dipping the laminated product in a solvent or an aqueous developing solution, particularly in an aqueous alkaline solution, or by spraying a developing solution followed by rubbing with a brush, or otherwise, development may be conducted with applying ultrasonic waves. In order to accelerate curing reaction, UV irradiation and heat-treatment may further be carried out after development.

UV irradiation may be conducted either from the side having a color filter formed on a substrate or from the opposite side. Alternatively, UV irradiation may be carried out from both sides simultaneously or separately.

The above-described steps are repeated several times toward respective colored photosensitive resin layers to thereby form a color filter on a substrate. By conducting the above-described steps, a dot-shaped pattern, having a large number of non-colored regions which do not constitute colored pixels (empty portions), can be provided in at least a part of an area within a single pixel in the direction of layer thickness or layer lamination, among pixels which are patterned with plural colors arranged on a transparent substrate.

Next, in case where non-colored regions that do not have colored portions constituting colored pixels are transparent non-colored portions, the method of coating, printing, transfer or the like is employed to provide on the colored pixels a colorless photosensitive resin composition layer or a colored photosensitive resin composition layer containing a discolorable dye. Transfer is particularly preferable in view of simple processing.

In transfer method, a transfer material comprising a tentative support having disposed thereon at least, instead of a colored photosensitive layer, a layer of a colorless photosensitive resin composition or a photosensitive resin composition containing a discolorable dye, is adhered to a surface of colored pixels, and then a region having no colored portion to constitute colored pixels (an empty portion) is filled with a colorless photosensitive resin composition or a photosensitive resin composition containing a discolorable dye.

Thereafter, in a similar manner conducted to a transfer material which is provided with a colored photosensitive material, the transfer material is exposed to light and then developed. If the colored pixels that have already been formed contain a UV absorbent and if light exposure is conducted from the side of a substrate after the transfer material containing a colorless photosensitive resin composition or a photosensitive resin composition containing a discolorable dye has been transferred, the pre-formed pixels serve as a mask, and hence a layer of a colorless photosensitive resin composition or a photosensitive resin composition containing a discolorable dye can be produced at only the portions where pixels have not been formed. Then, the resultant layer may further be cured by performing flood exposure and additionally heat-treatment. Development is conducted in a substantially similar manner to that applied for a colored photosensitive resin layer. Conventionally known compositions which are developable with an aqueous alkaline solution or developable with an organic solvent may be used, and the compositions which are developable with an aqueous alkaline solution are preferable from the viewpoints of preventing environmental pollution and securing working safety.

The thickness of the colorless photosensitive resin composition layer or the photosensitive resin composition layer containing a discolorable dye is determined by the thickness of a layer to be finally formed on the color filter. The thickness of each layer is preferably 0.1 to 5 μm, more preferably 0.3 to 4 μm in consideration of a difference in level of the layer among pixels, a decrease in the thickness of the layer during the heat treatment such as post-baking, color density in respective colored layers and development suitability.

In the invention, a spacer can be formed simultaneously with forming a dot-shaped pattern. This method for forming a spacer comprises, for example, providing on colored pixels a colorless photosensitive resin composition layer or a photosensitive resin composition layer containing a discolorable dye, conducting UV flood exposure from the side of the substrate opposed to the face having formed pixels, and further conducting UV irradiation from the side of the face having colored pixels through a photomask having a pattern corresponding to an arrangement of a spacer.

Then, the layer of the photosensitive resin composition containing a discolorable dye is cured in the area having dot-shaped pores, removing the photosensitive resin composition layer containing a discolorable dye formed on the surface of respective pixels (unnecessary portions), irradiating UV rays using a high-pressure mercury lamp, followed by heat-treatment, to finally form a color filter in which dot-shaped patterns are formed and spacers are arranged in a predetermined positions.

### EXAMPLES

### Example 1

Preparation of Transfer Material

(A Transfer Material Comprising a Tentative Support Having Disposed Thereon a Colored Photosensitive Resin Layer)

A coating solution having the following formulation H1 was prepared and applied onto a polyethylene terephthalate film, which serves as a tentative support and has 75 μm in thickness, followed by drying to provide a thermoplastic resin layer having a thickness of 20 μm after dried.

(Thermoplastic Resin Layer Formulation: H1)

| | | |
|---|---|---|
| Methyl methacrylate/2-ethyl hexyl acrylate/benzyl | 15 | parts by weight |
| methacrylate/methacrylic acid copolymer | | |
| (copolymerization ratio (molar ratio) = | | |
| 55/28.8/11.7/4.5, weight average molecular | | |
| weight = 90,000) | | |
| Polypropylene glycol diacrylate (average molecular | 6.5 | parts by weight |
| weight = 822) | | |
| Tetraethylene glycol dimethacrylate | 1.5 | parts by weight |
| p-Toluene sulfonamide | 0.5 | part by weight |
| Benzophenone | 1.0 | part by weight |
| Methyl ethyl ketone | 30 | parts by weight |

Then, a coating solution having the following formulation B1 was applied onto the thus formed thermoplastic resin layer followed by drying to provide an interlayer.

(Interlayer formulation: B1)

| | | |
|---|---|---|
| Polyvinyl alcohol (PVA205, saponification | 130 | parts by weight |
| degree = 80%, produced by Kuraray Co., Ltd.) | | |
| Polyvinyl pyrrolidone (PVP, K-90, produced by | 60 | parts by weight |
| GAF Corporation) | | |
| Fluorine-containing surfactant (Surflon S-131, | 10 | parts by weight |
| produced by Asahi Glass Company) | | |
| Distilled water | 3,350 | parts by weight |

Photosensitive coating solutions for three colors, i.e., red (for R layer), green (for G layer) and blue (for B layer), respectively, having the formulations shown in Table 1 (to respective solutions, SHIGENOX 102 produced by Hakkol Chemical Co., Ltd. was added as a UV absorbent in an amount of 10% by mass relative to a total solid content) were applied onto the above tentative support having disposed thereon a thermoplastic resin layer and an interlayer followed by drying, to form respective colored photosensitive resin composition layers having 2.0 μm in thickness. The numerical values in Table 1 are expressed in “g”.

TABLE 1

| | Red | Green | Blue |
|---|---|---|---|
| Benzyl methacrylate/methacrylic acid | 60 | 33.5 | 34.1 |
| copolymer (molar ratio = 73/27, molecular | | | |
| weight 30,000) | | | |
| Pentaerythritol hexaacrylate | 28.4 | 25.2 | 32.3 |
| Fluorine-containing surfactant (Megafack | 0.37 | 0.19 | 0.30 |
| F177P, Dainippon Ink and Chemicals, | | | |
| Incorporated) | | | |
| 2,4-Bis(trichloromethyl)-s-[4-(N,N- | 1.31 | 0 | 1.52 |
| diethoxycarbonylmethyl)]-s-triazine | | | |
| 2-Trichloromethyl-5-(p-styrylstyryl)-1,3,4- | 0 | 1.2 | 0 |
| oxadiazole | | | |
| Phenothiazine | 0.02 | 0.020 | 0.026 |
| Chromophthal Red A2B (red) | 27 | 0 | 0 |
| Paliotol Yellow L1620 | 10.3 | 23.0 | 0 |
| Heliogen Blue L6700F (blue) | 0 | 0 | 25.6 |
| Monastral Green (green) | 0 | 23.0 | 0 |
| Methoxypropylene glycol acetate | 310 | 310 | 310 |
| Methyl ethyl ketone | 460 | 460 | 460 |

The thickness of the thus prepared photosensitive resin composition layers for respective three colors (R, G, B) formed on the tentative support and the variation in thickness thereof (within a 50 cm×50 cm area) were assessed and found to be 2.0±0.08 μm for R, 2.0±0.09 μm for G, and 2.0±0.08 μm for B, respectively.

A covering sheet of polypropylene (thickness 12 μm) was contact-bonded onto the respective photosensitive resin composition layers to prepare an image forming material having red, blue, green and black colors (a transfer material).

(A Transfer Material Comprising a Colored Photosensitive Resin Composition Layer Containing a Discolorable Dye)

A photosensitive resin composition containing a discolorable dye having the formulation shown in Table 2 below was coated on a tentative support provided with a thermoplastic resin layer and an interlayer, which was the same support as employed for forming the colored photosensitive resin composition layer described above, followed by dying, to form a photosensitive resin composition layer containing a discolorable dye and having a thickness of 2.0 μm after dried.

TABLE 2
Colored photosensitive resin composition containing a
discolorable dye

| | |
|---|---|
| Methacrylic acid/benzyl methacrylate copolymer | 17.82 g |
| (molar ratio: 28/72, weight average molecular weight: 30,000) | |
| Pentaerythritol tetraacrylate | 10.53 g |
| Victoria Pure Blue | 0.50 g |
| Surfactant (F177P, Dainippon Ink and Chemicals, | 0.05 g |
| Incorporated) | |
| Photopolymerization initiator (2,4-bis(trichloromethyl)-6- | 0.5 g |
| [4-(N,N-diethoxycarbomethyl)-3-bromophenyl]-s-triazine | |
| Methyl ethyl ketone | 108.24 g |
| Propylene glycol monomethyl ether acetate | 41.25 g |

The thickness of the thus prepared colored photosensitive resin composition layers and the variation in thickness thereof (within a 50 cm×50 cm area) were assessed and found to be 2.0±0.08 μm and 2.0±0.07 μm, respectively.

Further, a covering sheet of polypropylene (thickness 12 μm) was contact-bonded onto the photosensitive resin composition layers to prepare a transfer material comprising a colored photosensitive resin composition layer containing a discolorable dye.

Preparation of Color Filter

Using the transfer material described above, a color filter was prepared by the following method.

A 400 mm×300 mm transparent glass substrate having 1.1 mm in thickness (#7059, Corning Co., Ltd.) was washed, dipped in a 1% aqueous solution of silane coupling agent (KBM-603, Shin-Etsu Chemical Co., Ltd.) for 3 minutes, rinsed with purified water for 30 seconds to wash out an excessive silane coupling agent, drained, followed by heat-treatment in an oven at 110° C. for 20 minutes. A covering sheet for a red-image forming material was peeled off, and the surface of the photosensitive resin composition layer was adhered using an auto-cut laminator (ASL-24, Somar Corp.), under pressure (10 kg/cm²) and heating, to the transparent glass substrate pre-treated with the silane coupling agent, and the tentative support was peeled off at the interface between the tentative support and the thermoplastic resin layer. Then, the resulting laminate was exposed to light through a photomask having a plurality of pixel patterns consisting of dot-shaped, light-transmitting regions around a completely light-transmitting region, developed to remove unnecessary portions (uncured portions), irradiated with UV rays at an intensity of 300 mj/cm² from the side opposite to the color filter-formed face using a super-high pressure mercury vapor lamp, and heat-treated at 220° C. for 20 minutes, to thereby form a red pixel pattern on the transparent glass substrate. The formed red pixel contained a plurality of patterns having dot-shaped pores around a central region in a single pixel.

Then, a green image-forming material (transfer material) was laminated on the glass substrate having already formed thereon the red pixel pattern and subjected to peeling, light exposure, development, post-exposure and heat-treatment, to thereby form a green pixel pattern having a pattern similar to the red pixel pattern. Using a blue image-forming material (transfer material), the same processings were repeated to thereby form a blue pixel pattern. After the three color patterns were formed, a final baking was carried out to thus form, on the transparent glass substrate, red, green and blue pixels each containing a plurality of patterns having dot-shaped pores around a central region in a single pixel.

Incidentally, the dots (the area where the photosensitive resin layer have been removed) in the dot-shaped, light transmitting regions had the shape of a slit which is longitudinally long in the longer direction of a pixel so as to make up for resolution of the photosensitive resin layer composition. Due to this shape, the region containing dot-shaped pores could securely be formed.

Then, using a transfer material comprising a photosensitive resin composition layer containing a discolorable dye, the side thereof having the photosensitive layer was adhered by means of an auto-cut laminator (ASL-24, Somar Corp.), under pressure (10 kg/cm²) and heating, to the face having formed pixels as above. At this point, in the region containing dot-shaped pores formed on the respective pixel surfaces, a photosensitive resin composition layer containing a discolorable dye was formed.

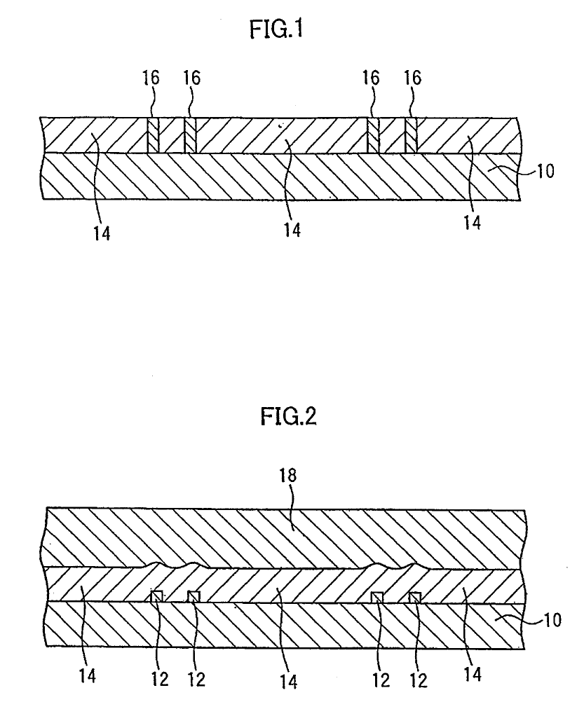

Then, the tentative support was peeled and removed at the interface with a thermoplastic resin layer. The resultant laminate was exposed to light from the substrate side, opposite to the side having formed pixels, to cure the photosensitive resin composition layer containing a discolorable dye, followed by removing the photosensitive resin composition layer containing the discolorable dye (uncured and unnecessary portions) formed on the surface of pixels. Thereafter, the resultant material was irradiated with 300 mj/cm² UV rays using a super-high pressure mercury vapor lamp and heated at 220° C. for 2 hours. As a result of the heating, the photosensitive resin composition layer containing the discolorable dye formed within the region that includes the dot-shaped pores caused discoloration, to thereby turn substantially colorless and transparent. A sectional view of the resultant color filter formed on a substrate is shown in FIG. 1. In FIG. 1, numeral 10 denotes a transparent glass substrate, 14 denotes colored pixels and 16 denotes a transparent non-colored portion.

When this color filter was applied to the reflective-and-transmissive-type display, a reflective portion became lighter and, even if a sufficient amount of light reached a reflective portion, color purity at a transmissive portion was not impaired, while even if color purity at a transmissive portion was sufficient, the reflective portion did not undesirably grow dark.

### Example 2

A color filter in which red, green and blue pixels including a plurality of patterns having dot-shaped pores around a respective central region in a single pixel were formed was produced on a transparent glass substrate as conducted in Example 1, except that the transparent non-colored portion was not formed, i.e., the transparent colorless portions were empty portions. The thus produced color filter exhibited the same effects as exerted by the color filter obtained in Example 1.

### Example 3

Using the same colored image forming material (transfer material) as employed in Example 1, a color filter was prepared in the following manner.

A resist material OFPR-800 (Tokyo Ohka Kogyo Co., Ltd.) was spin-coated on the entire surface of a 400 mm×300 mm transparent glass substrate of 1.1 mm in thickness (#7059, Corning Co., Ltd.) and then dried at 100° C. for 2 minutes to form a film having 0.8 μm in thickness. Light exposure was conducted through a photomask having a dot-shaped pattern followed by development. As the developing solution, NMD-3 (2.38%) produced by Tokyo Ohka Kogyo Co., Ltd. was used. Thereafter, heat-treatment was conducted at 180° C. for 40 minutes. Then, onto a surface coated with a resist layer having a dot-shaped pattern was formed a layer Al having a thickness of 0.2 μm by vacuum deposition. Unnecessary portions (uncured portions) were removed by a photolithographic processing and then etched to thereby form a reflective layer having a dot-shape (having the shape of a slit which was longitudinally long in the longer direction of a pixel). The substrate having a patterned reflective layer was washed, dipped in a 1% aqueous solution of silane coupling agent (KBM-603, Shin-Etsu Chemical Co., Ltd.) for 3 minutes, rinsed with purified water for 30 seconds to wash out an excessive silane coupling agent, drained, and subjected to heat-treatment in an oven at 110° C. for 20 minutes. A covering sheet for a red-image forming material was peeled off, and the surface of the photosensitive resin composition layer was adhered using an auto-cut laminator (ASL-24, Somar Corp.), under pressure (10 kg/cm²) and heating, to the transparent glass substrate pre-treated with the silane coupling agent, and the tentative support was peeled off at the interface between the tentative support and the thermoplastic resin layer. Then, the resulting laminate was exposed to light through a photomask having no dot-shaped patterns, developed to remove unnecessary portions (uncured portions), irradiated with UV rays at an intensity of 300 mj/cm² from the side having the color filter-formed face using a super-high pressure mercury vapor lamp, and heat-treated, to thereby form a red pixel pattern onto the transparent glass substrate. Then, a green image-forming material (transfer material) was adhered in a similar manner to the above to the glass substrate having already formed thereon the red pixel pattern and subjected to peeling, light exposure, development, post-exposure and heat-treatment, to thereby form a green pixel pattern. Using a blue image-forming material (transfer material), the same processings were repeated to thus produce a color filter. After the color filter having three color patterns was formed, a final baking was carried out at 220° C. for 120 minutes.

An overcoat layer was formed using the above-described transfer material comprising a photosensitive resin composition layer containing a discolorable dye.

The side having the photosensitive resin composition layer was adhered by means of an auto-cut laminator (ASL-24, Somar Corp.), under pressure (10 kg/cm²) and heating, to the face having formed a color filter as above.

Then, the tentative support was peeled and removed at the interface with a thermoplastic resin layer. The resultant laminate was exposed to light from the side having formed colored pixels, to harden the photosensitive resin composition layer containing a discolorable dye, followed by removing the photosensitive resin composition layer containing the discolorable dye (unnecessary portions). Thereafter, the resultant laminate was irradiated with 300 mj/cm² UV rays using a super-high pressure mercury vapor lamp and heated at 220° C. for 2 hours. As a result of the heating, the photosensitive resin composition layer containing the discolorable dye formed on the surface having formed pixels caused discoloration, to thereby give a substantially colorless and transparent overcoat layer.

A sectional view of the resultant color filter formed on a substrate is shown in FIG. 2. In FIG. 2, numerical 10 denotes a transparent glass substrate, 12 denotes a reflective layer, 14 denotes colored pixels and 18 denotes an overcoat layer.

The thus produced color filter having no colored dot-shaped pattern exhibited the same effects as exerted by a color filter obtained in Examples 1, by forming a reflective plate.

### Example 4

Red, green and blue pixels including a plurality of patterns having dot-shaped pores around a respective central region was formed on a transparent glass substrate as conducted in Example 1.

Then, using the above-described transfer material, the side having the photosensitive resin composition layer was adhered using an auto-cut laminator (ASL-25, Somar Corp.), under pressure (10 kg/cm²) and heating, to the entire surface of the colored pixels.

Thereafter, the tentative support was peeled and removed at the interface with a thermoplastic resin layer. The resultant laminate was exposed to UV rays through a photomask having a pattern corresponding to a pre-arranged spacer from the side having formed colored pixels, developed to remove the photosensitive resin composition layer containing the discolorable dye (uncured and unnecessary portions). Then, the face having the photosensitive resin composition was irradiated with 300 mj/cm² UV rays and heated at 220° C. for 2 hours. As a result, a color filter having a spacer at a predetermined position was produced.

The thus produced color filter had an enhanced lightness at a reflective portion and, even if a sufficient amount of light reached a reflective display, color purity at a transmissive portion was not impaired, while even if color purity at a transmissive portion was sufficient, the reflective portion did not undesirably grow dark. Furthermore, a spacer could be formed together with the dot-shaped pattern in respective color pixels, by employing a simple processing.

### Comparative Example

A color filter was produced in a similar manner to Example 1, except that an ordinary photomask was used for light exposure, i.e., without using a photomask having a dot-shaped pattern. That is, the thus produced color filter did not have a dot-shaped pattern in respective pixels. In this produced color filter, when a sufficient amount of light reached a reflective display, color purity at a transmissive portion was insufficient, and when color purity at a transmissive portion was sufficient, the reflective portion undesirably grew dark.

According to the present invention, a color filter used for reflective-and-transmissive-type liquid crystal displays can readily be produced with which color purity at a transmissive portion is not impaired even if a sufficient amount of light reaches a reflective portion, while a reflective portion does not undesirably grow dark even if color purity at a transmissive portion is sufficient.

What is claimed is:

1. A color filter provided on a transparent support, wherein a dot-shaped pattern, having a large number of non-colored regions which do not constitute colored pixels, is provided in at least a part of an area within a single pixel in the direction of layer thickness or layer lamination, among pixels which are patterned with plural colors.

2. The color filter according to claim 1, wherein the non-colored regions which do not constitute colored pixels comprise a transparent non-colored portion.

3. The color filter according to claim 1, wherein the non-colored regions which do not constitute colored pixels comprise a reflective layer.

4. The color filter according to claim 2, wherein a large number of transparent non-colored portions are formed in the direction of layer thickness in the shape of a column or a plate and the ratio of a transparent non-colored portion to a colored portion within a single pixel is 1:0.1 to 0.1:1.

5. The color filter according to claim 4, wherein the area of a transparent non-colored portion in a single pixel is 50 to 10,000 μm².

6. The color filter according to claim 1, further comprising an overcoat layer on the surface of colored pixels.

7. A process for producing a color filter comprising the steps of:
(1) providing a colored photosensitive resin composition layer on a transparent substrate;
(2) irradiating light through a photomask having a plurality of pixel patterns consisting of a completely light-transmitting region and a dot-shaped light-transmitting region; and
(3) developing the irradiated colored photosensitive resin composition layer and removing unnecessary portions thereof.

8. The process according to claim 7, further comprises after the step of (3), additional steps of:
(4) flood-exposure; and
(5) heat-treatment,
and all of the steps (1) to (5) are repeated.

9. The process according to claim 7, wherein the step of providing a colored photosensitive resin composition layer on a transparent substrate comprises transferring said layer onto said substrate by using a transfer material containing a tentative support having disposed thereon said layer.

10. The process according to claim 7, further comprising additional steps of:
exposing a resist material arranged on an entire surface of the transparent substrate to light through a photomask having a dot-shaped pattern, developing and heat-treating, forming a metal thin film, and etching the formed metal thin film by a photolithographic processing to provide a reflective layer having a dot-shaped pattern, and thereafter
carrying out said steps (1) to (3) on the surface having said reflective layer, to thereby form a dot-shaped pattern.

11. The process according to claim 7, further comprises after the step of (3), additional steps of:
(6) providing a colorless photosensitive resin composition layer or a colored photosensitive resin composition layer containing a discolorable dye;
(7) irradiating light from the side of a substrate; and
(8) developing the irradiated colorless photosensitive resin composition layer or the irradiated photosensitive resin composition layer containing a discolorable dye and removing unnecessary portions thereof, and the steps (1) to (3) and (6) to (8) are repeated.

12. The process according to claim 8, further comprises after the step of (5), additional steps of:
(6) providing a colorless photosensitive resin composition layer or a colored photosensitive resin composition layer containing a discolorable dye;
(7) irradiating light from the side of a substrate; and
(8) developing the irradiated colorless photosensitive resin composition layer or the irradiated photosensitive resin composition layer containing a discolorable dye and removing unnecessary portions thereof, and the steps (1) to (8) are repeated.

13. The process according to claim 11, further comprises after the step of (8), additional steps of:
(9) flood-exposure; and
(10) heat-treatment, and the steps (1) to (10) are repeated.

14. The process according to claim 11, wherein a spacer is formed together with a dot-shaped pattern in said steps of (6) to (8).

15. The process according to claim 11, wherein the step of providing a colorless photosensitive resin composition layer or a photosensitive resin composition layer containing a discolorable dye on a transparent substrate comprises transferring said layer onto said substrate by using a transfer material containing a tentative support having disposed thereon said layer.
